(19) United States
(12) Patent Application Publication
(10) Pub. No.: US 2005/0038763 A1
(43) Pub. Date: Feb. 17, 2005

(54) Methodology for prediction of shallow ground water levels

(76) Inventors: George Martin Cole, Monticello, FL (US); Sanford Ney Young, Tallahassee, FL (US)

Correspondence Address: George M. Cole, 5283 Ashville Highway, Monticello, FL, 32344, US

(21) Appl. No.: 10/640,391

(22) Filed: Aug. 14, 2003

(51) Int. Cl. G06E 1/00

(52) U.S. Cl. 706/20

(57) ABSTRACT

The invention is a process for the development and use of a model for the prediction of shallow ground water level fluctuation. This approach involves using site specific ground water observations for the determination of rate of decline due to infiltration and rate of rise due to precipitation for the ground water level at a site, followed by use of those rates with historic precipitation records to estimate the extent of historic saturation and inundation periods at the site. That information may then be used for the delineation of jurisdictional wetlands and other similar applications. The steps of the process are as follows: 1. Short-term on-site observations of ground water level and rainfall 2. Statistical analysis to determine rainfall response and infiltration rates to develop site model 3. Prediction of past ground water levels using historic rainfall records for the region 4. Estimation of percentage of years meeting wetland regulation criteria

### CROSS-REFERENCE TO RELATED APPLICATIONS

N/A

### STATEMENT REGARDING FEDERALLY SPONSORED RESEARCH OR DEVELOPMENT

N/A

### REFERENCE TO SEQUENCE LISTING, A TABLE, OR A COMPUTER PROGRAM LISTING COMPACT DISK APPENDIX

N/A

### BACKGROUND OF THE INVENTION

1. Field of the Invention

The invention pertains to the field of wetlands hydrology.

2. Technical Background

In most jurisdictions, the currently accepted methodology for wetlands delineation for regulation purposes is based primarily on the analysis of vegetation and soil type. These traditional methodologies do not always result in a line meeting the two previously mentioned requirements for a good boundary: precision and the lack of ambiguity. In addition, these methodologies do not always reflect current conditions where alteration has occurred. This has often resulted in prolonged and bitter disputes over the interpretation of vegetative and soil evidence.

As a result of such controversy, there has been an increased interest in developing more objective hydrologic criteria, using the actual presence of water as opposed to indicator of the presence of water. Typical of such interest, the State of Florida has promulgated administrative rules allowing the use of hydrologic data and analysis for the refuting of a delineation of wetlands “by either reliable hydrologic records or site specific hydrologic data which indicate that neither inundation for at least seven consecutive days, nor saturation for at least twenty consecutive days occurs during conditions which represent long-term hydrologic conditions.” Inundation is defined by that rule as “a condition in which water from any source regularly and periodically covers a land surface.” Saturation is defined as having a water table six inches or less from the soil surface for soils with a permeability equal to or greater than six inches per hour or a water table 12 inches or less from the soil surface for soils with a permeability less than six inches per hour. (Section 17-340, Florida Administrative Code). Somewhat similar criteria are provided by the 1987 U.S. Army Corps of Engineers manual for the definition of wetlands regulated by Section 404 of the Clean Water Act. These may be summarized as requiring the water table to be less than 12 inches from the surface continuously for at least five percent of the growing season under normal conditions.

Thus, as may be seen from the above, legally acceptable criteria for use of hydrology for delineation of wetlands exist. Yet, such criteria have been rarely utilized. The primary reason for this is that the criteria require “long term” or “normal” conditions, thus suggesting the requirement for lengthy observations to be representative of the norm. The invention has been developed as a means of determining such long-term conditions for a site with a minimum of observations.

### RELATED ART

The invention is a mathematical approach for determining whether the ground water level in a specific area meets criteria, such as those described above, for regulation as wetlands. The process uses observations of the water level itself, as opposed to indicators of the water level. The process uses such short-term on-site observations to develop a model of the infiltration rate and rainfall response rate for the site followed by use of those rates with historic precipitation records to estimate the extent of historic saturation and inundation periods at the site. No prior art has been found using or anticipating such a process.

As suggested in the initial examination of this application, Coppola et al. (US 2003/0078901) claims a process for predicting and optimizing water attributes. However, that process utilizes a neural network designed primarily for water management purposes. Coppola et al. does not appear to anticipate a input-output model designed to model and estimate historic ground water levels for wetland delineation purposes as proposed in this application, and the Coppola is not capable of determining historic frequencies of inundation or saturation.

Referring to the other references cited in the initial examination, Edward J. McCarthy (U.S. Pat. No. 5,342,144) covers a storm water control system and deals with water quality, not water quantity for wetland boundary delineation as proposed in this application. Leslie L. Behrends (U.S. Pat. No. 5,863,433) deal with use of wastewater, again with emphasis on water quality, not water quantity for wetland boundary delineation as proposed in this application. Jed Margolin (U.S. Pat. No. 6,177,943) covers digital map compression and display and appears not to be at all related to the process proposed in this application. John A. Dufay (U.S. Pat. No. 6,159,371) construction of wetlands for remediation as opposed to the delineation of existing wetlands as proposed in this application; and Orr et al. (US-2003/0061012) covers a digital model for community development and planning and not the delineation of wetlands as proposed in this application. AU of these references are in related fields with the possible exception of Margolin, but are considerably different in process and application.

### BRIEF SUMMARY OF THE INVENTION

The invention is a process for the development and use of a model for the prediction of ground water level fluctuation. This process involves using on-site ground water observations for the determination of rate of decline due to infiltration and rate of rise due to precipitation for the ground water level at a site, followed by use of those rates with historic precipitation records to estimate the extent of historic saturation and inundation periods at the site. That information may then be used as an objective criterion for the delineation of the limits of wetlands subject to environmental regulation and other similar applications.

### DESCRIPTION OF THE DRAWINGS

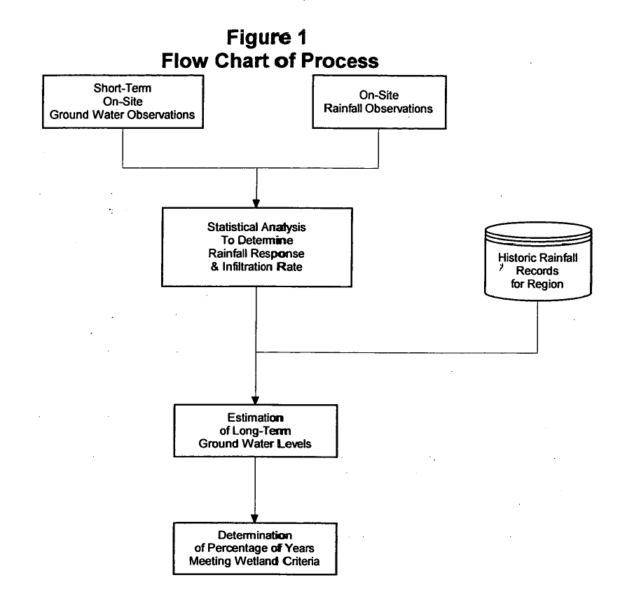

One drawing, FIG. 1 provides a flow chart of the process, depicting the steps of the process. These include short-term on-site observations of ground water level and rainfall, statistical analysis to determine rainfall response and infiltration rates to develop site model, prediction of past ground water levels using historic rainfall records for the region, and estimation of percentage of years meeting wetland regulation criteria.

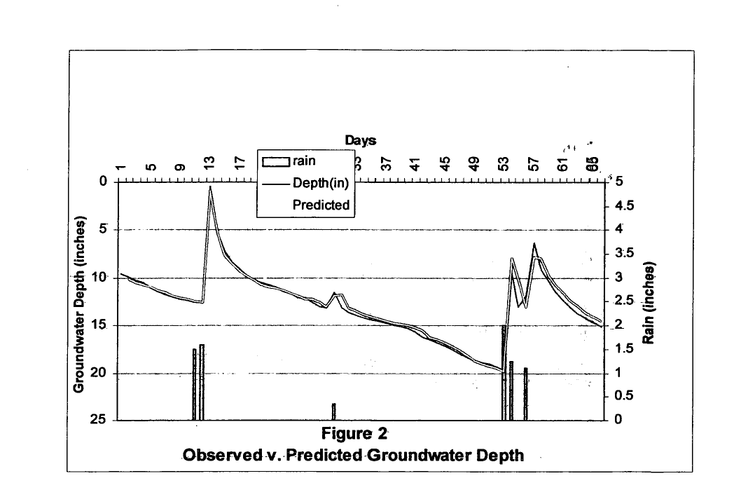

The second drawing, FIG. 2, illustrates the concept of the invention. That illustration illustrates a typical ground water level hydrograph. The figure illustrates the responding rise in ground water level, proportional to the volume of rainfall, associated with each rainfall event. The figure also illustrates the consistent decline of the ground water level between rainfall events. In addition, FIG. 2 illustrates the ability to closely predict the ground water level fluctuations with a mathematical formula, derived statistically from ground water observations at the site.

### DETAILED DESCRIPTION OF THE INVENTION

The invented process involves groundwater level observations at the site under study to develop the average rates for groundwater level change under various meteorological conditions. These rates, together with historic rainfall data, are then used to determine the historic frequency of saturation.

Data Acquisition—The process requires on-site observations of ground water level and rainfall. This may be accomplished by use of manual depth readings in shallow wells and manually read rain gauges or by automated sensors. The required duration of the observations will vary with location and meteorological conditions, but should at a minimum, cover several rainfall events and several periods of no precipitation

Ground Water Model—For any period of time, the change in the level of ground water may be expressed as follows:
change in depth=decline+evapotranspiration−rainfall response (1)
In the above equation, decline is defined as the lowering of the ground water level due to infiltration of the water into deeper levels of the ground. Evapotranspiration is defined as the lowering of the ground water level due to evaporation, both from the surface and from plant life. Rainfall response is defined as the resulting rise in ground water level due to rainfall. Note: The term “evapotranspiration” is a long accepted term of art. Typical definitions of that process may be found in references such as the following:
Thornthwaite, C. W. (1948). “An Approach Toward a Rational Classification of Climate”. Geographical Review 38:55-94
Ward, Andy D. and William J. Elliot (1995). Chapters 1-5 (The Hydrologic Cycle, Precipitation, Infiltration, Evapotranspiration, Surface Runoff and Subsurface Drainage) Environmental Hydrology. Boca Raton: Lewis Publishers.
Zy, Yin (1992). “Evapotranspiration in the Okefenokee Swamp Watershed—A Comparison of Temperature-Based and Water-Balance Methods” Journal of Hydrology 131 (14): 293-312 February 1992

Determination of Infiltration Rate and Rainfall Response—Using Equation 1 as a basis, statistical analysis is conducted to find the best-fit values for the rainfall response and rate of decline. For this solution, average values for evapotranspiration for each month are used and may be based on calculated theoretical values or on on-site observations.

Prediction of Past Ground Water Levels—Using long-term daily rainfall records for the region together with the values for the infiltration and rainfall response, a prediction may be performed for each year for which rainfall records are available, using the equation derived from the regression. For this prediction, the average values of evapotranspiration for each month, based on calculated theoretical values, are used.

As a conservative arbitrary starting point for the prediction, the process assumes that the ground water level is at the surface at the beginning of each year. From that point of beginning, the level is predicted for each successive day in the year to determine periods in which the level is above the critical depth for saturation or inundation, depending on the regulatory criteria used.

Evaluation of Predicted Ground Water Level vs. Hydrologic Definitions of Wetlands—If the prediction of past ground water levels indicates that there has been periods of saturation or inundation for at least the number of consecutive days defined by the regulating agency for at least half of the years for which rain records are available, the site would be considered as wetlands under those criteria.

1: A process for the development and use of a mathematical model for the prediction of shallow ground water level fluctuation based on site specific ground water observations for the determination of rate of decline due to infiltration and evapotranspiration, and the rate of rise due to precipitation for the ground water level at a site; followed by use of those rates with historic precipitation records to estimate the extent of historic saturation and inundation periods at the site
